(19) United States
(12) Patent Application Publication
(10) Pub. No.: US 2026/0095384 A1
(43) Pub. Date: Apr. 2, 2026

(54) METHODS, SYSTEMS, AND COMPUTER READABLE MEDIA FOR PROVIDING ACCESS TO COMMUNICATION NETWORK HEALTH INFORMATION USING COMMUNICATION-NETWORK-AWARE GENERATIVE ARTIFICIAL INTELLIGENCE (AI) RETRIEVAL AUGMENTED GENERATION (RAG) MODEL AND NETWORK FUNCTION (NF)

(71) Applicant: Oracle International Corporation, Redwood Shores, CA (US)

(72) Inventor: Ankit Srivastava, Gorakhpur (IN)

(21) Appl. No.: 18/900,565

(22) Filed: Sep. 27, 2024

(51) Int. Cl. H04L 41/16; H04L 41/02; H04L 43/0823

(52) U.S. Cl. CPC H04L 41/16; H04L 41/024; H04L 43/0847

(57) ABSTRACT

A method for providing access to communication network health information using a communication-network-aware generative AI RAG model includes receiving, as a first input to the RAG model, a query for communication network health information and receiving, as a second input to the RAG model, at least one feed of communication network health information regarding at least one NF. The method further includes using the query to extract, from the communication network health information regarding the at least one network function, context information for the query for communication network health information, providing the query and the context information as inputs to a base LLM component of the RAG model, and generating, as output, a query response including an indication of the communication network health information requested by the query and in a natural language format.

### TECHNICAL FIELD

The subject matter described herein relates to debugging and observability in communication networks, such as 5G, previous generation, and subsequent generation networks. More particularly, the subject matter described herein relates to methods, systems, and computer readable media for providing access to communication network health information using a communication-network-aware generative AI RAG model and an NF.

### BACKGROUND

In 5G telecommunications networks, a network function that provides service is referred to as a producer network function (NF) or NF service producer. A network function that consumes services is referred to as a consumer NF or NF service consumer. A network function can be a producer NF, a consumer NF, or both, depending on whether the network function is consuming, producing, or consuming and producing services. The terms “producer NF” and “NF service producer” are used interchangeably herein. Similarly, the terms “consumer NF” and “NF service consumer” are used interchangeably herein. The term “NF”, as used herein, is also intended to include service communication proxies (SCPs) and security edge protection proxies (SEPPs), which are referred to as network entities, instead of network functions, in 3GPP standards documents.

A given producer NF may have many service endpoints, where a service endpoint is the point of contact for one or more NF instances hosted by the producer NF. The service endpoint is identified by a combination of Internet protocol (IP) address and port number or a fully qualified domain name (FQDN) that resolves to an IP address and port number on a network node that hosts a producer NF. An NF instance is an instance of a producer NF that provides one or more services. A given producer NF may include more than one NF instance. It should also be noted that multiple NF instances can share the same service endpoint.

NFs register with an NF repository function (NRF). The NRF maintains profiles of available NF instances identifying the services supported by each NF instance. The profile of an NF instance is referred to in 3GPP TS 29.510 as an NF profile. NF instances can obtain information about other NF instances that have registered with the NRF through the NF discovery service operation. According to the NF discovery service operation, a consumer NF sends an NF discovery request to the NRF. The NF discovery request includes query parameters that the NRF uses to locate the NF profiles of producer NFs capable of providing the service identified by the query parameters. NF profiles are data structures that define the types of services provided by an NF instance as well as contact and capacity information regarding the NF instance.

SCPs route messages between NF instances. An SCP can also invoke the NF discovery service operation to learn about available producer NF instances. The case where the SCP uses the NF discovery service operation to obtain information about producer NF instances on behalf of consumer NFs is referred to as delegated discovery. Consumer NFs connect to the SCP, and the SCP load balances traffic among producer NF service instances that provide the required services or directly routes the traffic to the destination producer NF instance.

One issue that can arise in 5G, previous generation, and subsequent generation networks is that distributed network architectures face debugging and observability challenges. For example, observing network performance and debugging problems can require analysis of log files and message flows transmitted to and from each NF in a network. Each NF may have its own proprietary invoice for accessing performance and other data, which makes network data collection and analysis difficult. Cloud deployments of 5G NFs make observability and debugging of network issues even more difficult due to the distributed nature of such deployments.

Accordingly, in light of these and other difficulties, there exists a need for improved methods, systems, and computer readable media for providing access to communication network health information in distributed network architectures.

### SUMMARY

A method for providing access to communication network health information using a communication-network-aware generative artificial intelligence (AI) retrieval augmented generation (RAG) model includes receiving, as a first input to a communication-network-aware generative AI RAG model, a query for communication network health information. The method further includes receiving, as a second input to the communication-network-aware generative AI RAG model, at least one feed of communication network health information regarding at least one network function (NF). The method further includes using the query to extract, from the communication network health information regarding the at least one network function, context information for the query for communication network health information. The method further includes providing the query and the context information as inputs to a base large language model (LLM) component of the communication-network-aware generative AI RAG model. The method further includes generating, as output and by the base LLM component, a query response including an indication of the communication network health information requested by the query and in a natural language format.

According to another aspect of the subject matter described herein, the communication-network-aware generative AI RAG model comprises a 5G-network-aware generative AI RAG model.

According to another aspect of the subject matter described herein, receiving the query includes receiving the query for communication network health information in a natural language format.

According to another aspect of the subject matter described herein, receiving the query for communication network health information includes receiving the query requesting health status of a 5G network function.

According to another aspect of the subject matter described herein, receiving the at least one feed of communication network health information includes receiving the at least one feed as input to a communication-network-aware embedded model component of the communication-network-aware generative AI RAG model and the method further comprises storing the communication network health information regarding the at least one NF in a tokenized format in a vector database.

According to another aspect of the subject matter described herein, using query to extract context information from the communication network health information regarding the at least one network function includes identifying one or more tokens in the query and using the one or more tokens to extract the health information regarding the at least one network function from the vector database.

According to another aspect of the subject matter described herein, receiving the at least one feed of communication network health information regarding at least one NF includes receiving a plurality of feeds from a plurality of different NFs.

According to another aspect of the subject matter described herein, receiving the at least one feed includes receiving a single feed of network health information from a service communication proxy (SCP) and including network health information regarding a plurality of different NFs.

According to another aspect of the subject matter described herein, the communication-network-aware generative AI RAG model includes a chat interface and receiving the query for communication network health information includes receiving the query via the chat interface. According to another aspect of the subject matter described herein, the method for providing access to communication network health information includes providing the response to a user via the chat interface.

According to another aspect of the subject matter described herein, a system for providing access to communication network health information using a communication-network-aware generative artificial intelligence (AI) retrieval augmented generation (RAG) model is provided. The system includes at least one processor and a memory. The system further includes a communication-network-aware generative AI RAG model stored in the memory and executed by the at least one processor for receiving, as a first input, a query for communication network health information, receiving, as a second input, at least one feed of communication network health information regarding at least one network function (NF), using the query to extract, from the communication network health information regarding the at least one network function, context information for the query for communication network health information, providing the query and the context information as inputs to a base large language model (LLM) component of the communication-network-aware generative AI RAG model, and generating, as output and by the base LLM component, a query response including an indication of the communication network health information requested by the query and in a natural language format.

According to another aspect of the subject matter described herein, the communication-network-aware generative AI RAG model includes a communication-network-aware embedded model component configured to receive the at least one feed as input and store the communication network health information regarding the at least one NF in a tokenized format in a vector database.

According to another aspect of the subject matter described herein, the communication-network-aware embedded model component is configured to use the query to extract the context information from the communication network health information regarding the at least one network function by identifying one or more tokens in the query and using the one or more tokens to extract the health information regarding the at least one network function from the vector database.

According to another aspect of the subject matter described herein, the communication-network-aware generative AI RAG model is configured to receive a plurality of feeds of communication network health information from a plurality of different NFs.

According to another aspect of the subject matter described herein, the communication-network-aware generative AI RAG model is configured to receive a single feed of network health information from a service communication proxy (SCP) and including network health information regarding a plurality of different NFs.

According to another aspect of the subject matter described herein, the communication-network-aware generative AI RAG model includes a chat interface configured to receive the query for communication network health information.

According to another aspect of the subject matter described herein, one or more non-transitory computer readable media having stored thereon executable instructions that when executed by one or more processors of one or more computers control the one or more computers to perform steps are provided. The steps include receiving, as a first input to a communication-network-aware generative artificial intelligence (AI) retrieval augmented generation (RAG) model, a query for communication network health information. The steps further include providing, as a second input to the communication-network-aware generative AI RAG model, at least one feed of communication network health information regarding at least one network function (NF). The steps further include using the query to extract, from the communication network health information regarding the at least one network function, context information for the query for communication network health information. The steps further include providing the query and the context information as inputs to a base large language model (LLM) component of the communication-network-aware generative AI RAG model. The steps further include generating, as output and by the base LLM component, a query response including an indication of the communication network health information requested by the query and in a natural language format.

The subject matter described herein can be implemented in software in combination with hardware and/or firmware. For example, the subject matter described herein can be implemented in software executed by a processor. In one exemplary implementation, the subject matter described herein can be implemented using a non-transitory computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

Exemplary implementations of the subject matter described herein will now be explained with reference to the accompanying drawings, of which:

FIG. 1 is a network diagram illustrating an exemplary 5G system network architecture;

FIG. 2 is a block diagram illustrating a portion of the 5G core network in which NFs communicate using indirect communications via an SCP;

FIG. 3 is a block diagram illustrating exemplary components of a communication-network-aware generative AI RAG model and an SCP for providing access to communication network health information;

FIG. 4 is a block diagram illustrating exemplary implementation details of a communication-network-aware generative AI RAG model and an SCP for providing access to communication network health information;

FIG. 5 is a block diagram illustrating exemplary components of a communication-network-aware generative AI RAG model and a plurality of 5G NFs for providing access to communication network health information;

FIG. 6 is a block diagram illustrating a computing platform and a communication-network-aware generative AI RAG model implemented on the computing platform and an NF for providing a feed of network health data to the communication-network-aware generative AI RAG model; and

FIG. 7 is a flow chart illustrating an exemplary process for providing access to communication network health information using a communication-network-aware generative AI RAG model and an NF.

### DETAILED DESCRIPTION

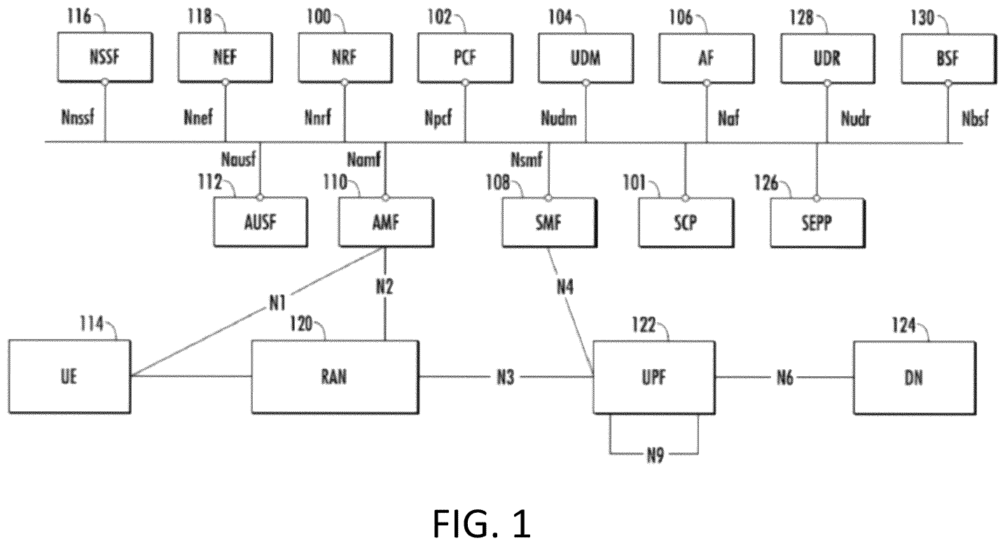

FIG. 1 is a network diagram illustrating an exemplary 5G system network architecture. The architecture in FIG. 1 includes NRF 100 and SCP 101, which may be located in the same home public land mobile network (HPLMN). As described above, NRF 100 may maintain profiles of available NF instances and their supported services and allow consumer NFs or SCPs to subscribe to and be notified of the registration of new/updated NF instances. SCP 101 may also support service discovery and selection of NF instances. SCP 101 may perform load balancing of connections between consumer and producer NFs.

NRF 100 is a repository for profiles of NF instances. To communicate with a producer NF instance, a consumer NF or an SCP must obtain the NF profile of the producer NF instance from NRF 100. The NF profile is a JavaScript object notation (JSON) data structure defined in 3GPP TS 29.510. The NF profile includes attributes that indicate the types of services provided, capacity of the NF instance, and information for contacting the NF instance.

In FIG. 1, any of the network functions can be consumer NFs, producer NFs, or both, depending on whether they are requesting, providing, or requesting and providing services. In the illustrated example, the NFs include a policy control function (PCF) 102 that performs policy related operations in a network, a unified data management function (UDM) 104 that manages user data, and an application function (AF) 106 that provides application services.

The NFs illustrated in FIG. 1 further include a session management function (SMF) 108 that manages sessions between an access and mobility management function (AMF) 110 and PCF 102. AMF 110 performs mobility management operations similar to those performed by a mobility management entity (MME) in 4G networks. An authentication server function (AUSF) 112 provides authentication services for user equipment (UEs), such as user equipment (UE) 114, seeking access to the network.

A network slice selection function (NSSF) 116 provides network slicing services for devices seeking to access specific network capabilities and characteristics associated with a network slice. NSSF 116 provides the NSSelection service, which allows NFs to request information about network slices and the NSSAIReachability service, which enables NFs to update and subscribe to receive notification of updates in network slice selection assistance information (NSSAI) reachability information.

A network exposure function (NEF) 118 provides application programming interfaces (APIs) for application functions seeking to obtain information about Internet of things (IoT) devices and other UEs attached to the network. NEF 118 performs similar functions to the service capability exposure function (SCEF) in 4G networks.

A radio access network (RAN) 120 connects user equipment (UE) 114 to the network via a wireless link. Radio access network 120 may be accessed using a gNB (not shown in FIG. 1) or other wireless access point. A user plane function (UPF) 122 can support various proxy functionality for user plane services. One example of such proxy functionality is multipath transmission control protocol (MPTCP) proxy functionality. UPF 122 may also support performance measurement functionality, which may be used by UE 114 to obtain network performance measurements. Also illustrated in FIG. 1 is a data network (DN) 124 through which UEs access data network services, such as Internet services.

A SEPP 126 filters incoming traffic from another PLMN and can perform topology hiding for traffic exiting the home PLMN. SEPP 126 may communicate with a SEPP in a foreign PLMN which manages security for the foreign PLMN. Thus, traffic between NFs in different PLMNs may traverse two SEPP functions, one for the home PLMN and the other for the foreign PLMN. A SEPP filtering egress messages from consumer NFs in a PLMN is referred to as a consumer SEPP or C-SEPP. A SEPP that filters ingress messages directed to producer NFs in a PLMN is referred to as a producer SEPP or P-SEPP. A given SEPP can function as a C-SEPP and a P-SEPP, depending on the role the SEPP is performing.

A unified data repository (UDR) 128 stores subscription data for UEs. A binding support function (BSF) 130 manages bindings between PDU sessions and PCFs.

As stated above, one issue in 5G, previous generation, and subsequent generation networks is providing access to network health information in distributed network architectures. 3GPP TS 23.501 defines the 5G system architecture as a service-based architecture, i.e., a system architecture in which the system functionality is achieved by a set of NFs providing services to other authorized NFs to access their services. An NF service is one type of capability exposed by an NF (NF service producer) to other authorized NFs (NF service consumers) through a service-based interface. A service-based interface represents how the set of services is provided or exposed by a given NF. This is the interface where the NF service operations are invoked.

The service-based architecture is distributed in nature. 5G NFs are implemented using a micro-service architecture and cloud native principles, which results in the 5G NFs being implemented in a distributed manner. 5G NFs are distributed at two levels:
within a Kubernetes cluster; and
geographically deployed in the network.

The distributed network faces observability and debugging challenges. Network operations teams can face severe challenges in debugging the distributed 5G core network. The 5G core needs a simplistic and automated interface which is available on-demand for debugging and for providing network health information.

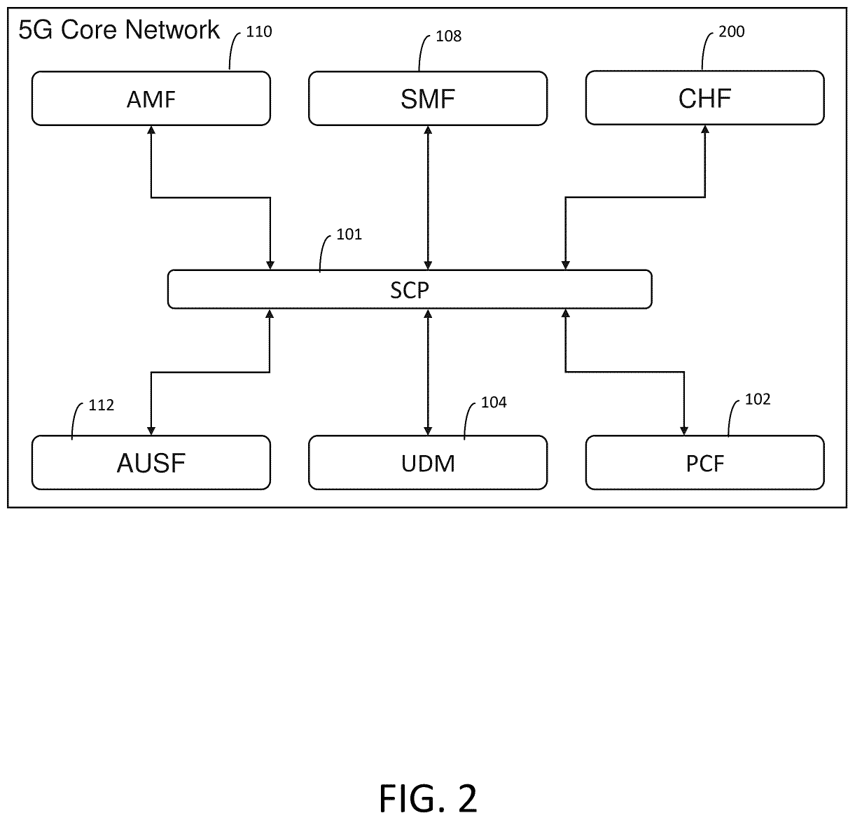

FIG. 2 is a block diagram illustrating a portion of the 5G core network in which NFs communicate using indirect communications via an SCP. In FIG. 2, AMF 110, SMF 108, charging function (CHF) 200, AUSF 112, UDM 104, and PCF 102 communicate using an indirect communication model via SCP 101. It is desirable to provide an easy-to-use interface for accessing network health information regarding the NFs illustrated in FIG. 2 and/or those illustrated in FIG. 1.

The subject matter described herein includes a communication-network-aware generative AI RAG model that uses network health information from an SCP to provide better and quick insight into the network health for faster debugging and observability. In one example, NFs in the 5G network communicate with each other indirectly via an SCP. The SCP may track and store the following network health information for NF-NF traffic:
status of NF-NF traffic, which makes the SCP aware of failure rate, latency pattern for every NF;
Processing load of each NF in the network;
Error rates and latency usable to identify NFs with degraded performance.

Th SCP generates various metrics and logs for NF error rate, latency patterns, overload, NF performance degradation, etc. The SCP feeds the health information to a generative AI RAG model which allows a user to provide a query for network health information in a natural language format, uses the network health information to provide context information to the query, provides the query and the context information to a large language model, and generates, in a natural language format, a query response including the requested network health information.

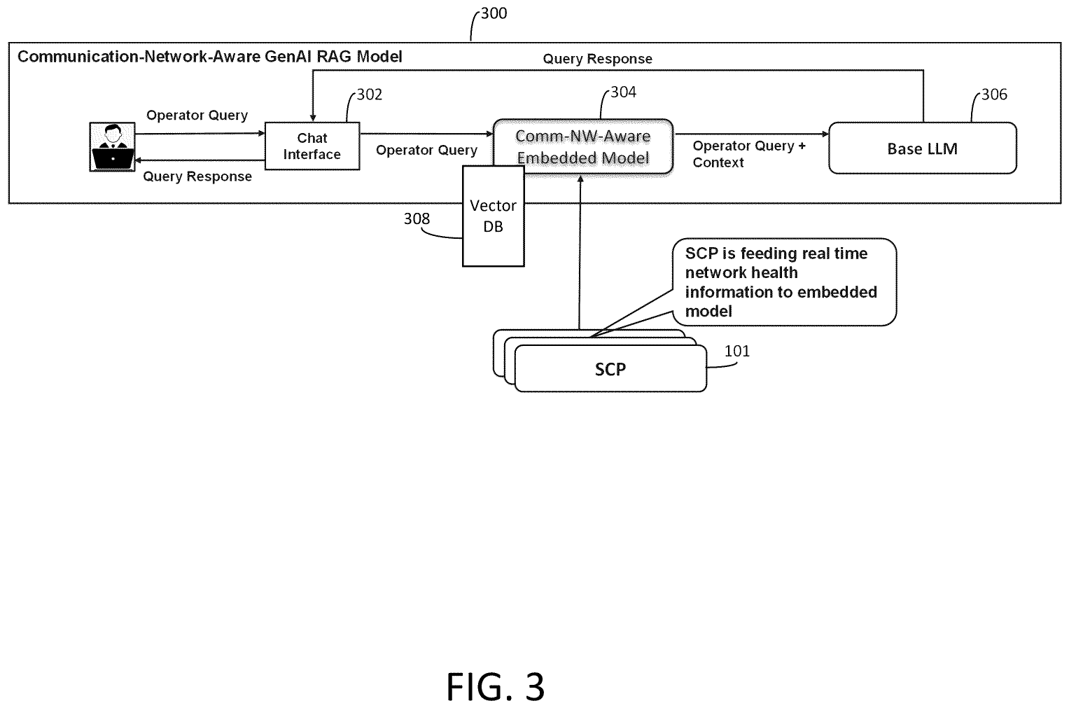

FIG. 3 is a block diagram illustrating exemplary components of a system including a communication-network-aware generative AI RAG model and an SCP for providing access to communication network health information. Referring to FIG. 3, the system includes a communication-network-aware generative AI RAG model 300. Communication-network-aware generative AI RAG model 300 includes a chat interface 302 that receives network health information queries in natural language format. For example, a network health information query in natural language format may be, “What is the error rate on the PCF interface. ” Communication-network-aware generative AI RAG model 300 also includes a communication-network-aware embedded model 304 that ingests information from external data sources and provides semantic context for the queries received via chat interface 302 to a base large language model 306. Communication-network aware embedded model 304 receives network health information from an external communication network data source, which, in the illustrated examples is SCP 101. SCP 101 provides network health information in the form of log files to communication-network-aware embedded model 304. Communication-network-aware embedded model 304 stores the communication network health information in a vector database 308 in which the communication network health information is tokenized so that it can be retrieved using tokens read from the health information queries. In the example query, “What is the error rate on the PCF interface,” the tokens used to access vector database 308 may be “PCF”, “error rate”, and “interface”. Base LLM 306 is a large language model that is pre-trained on massive amount of text data from various sources. Examples of suitable LLMs that can be used as base LLM 306 include Cohere, llama, and others.

The following are additional examples of queries that can be provided in text format to communication-network-aware generative AI RAG model 300 via chat interface 302:
What is the error rate for PCF interface?
What is the latency on UDM interface?
What is the error rate for roaming traffic?
What is the percentage of roaming traffic in the network?
Tell me the errors that happened in the network at timestamp 08:00 hours today?
   SCP 101 feeds metrics and logs of core communication network health information to embedded model 304, which makes embedded model 304 communication-network-aware. Communication-network-aware embedded model 304 generates dimensional vectors encoding semantic contexts and relationships among data tokens. An example of such a vector that may be stored in vector database 308 is as follows:
   Communication-network-aware embedded model 304 obtains tokens from the user query and searches for vectors in vector database 308 having tokens that match the tokens in the query. Communication-network-aware embedded model 304 provides the extracted vector(s) as context information along with the original query to base LLM 306. Base LLM 306 generates a response in natural language format and provides the response to the user via chat interface 302. Continuing with the PCF interface error rate example, a response in natural language format that may be generated by LLM 306 is, “The error rate on the PCF interface is 5 errors per hour. ” Providing the network health information as context information to base LLM 306 enables base LLM 306 to formulate the response from the context information, rather than the entire set of data sources upon which base LLM was trained, and results in more relevant and accurate responses.

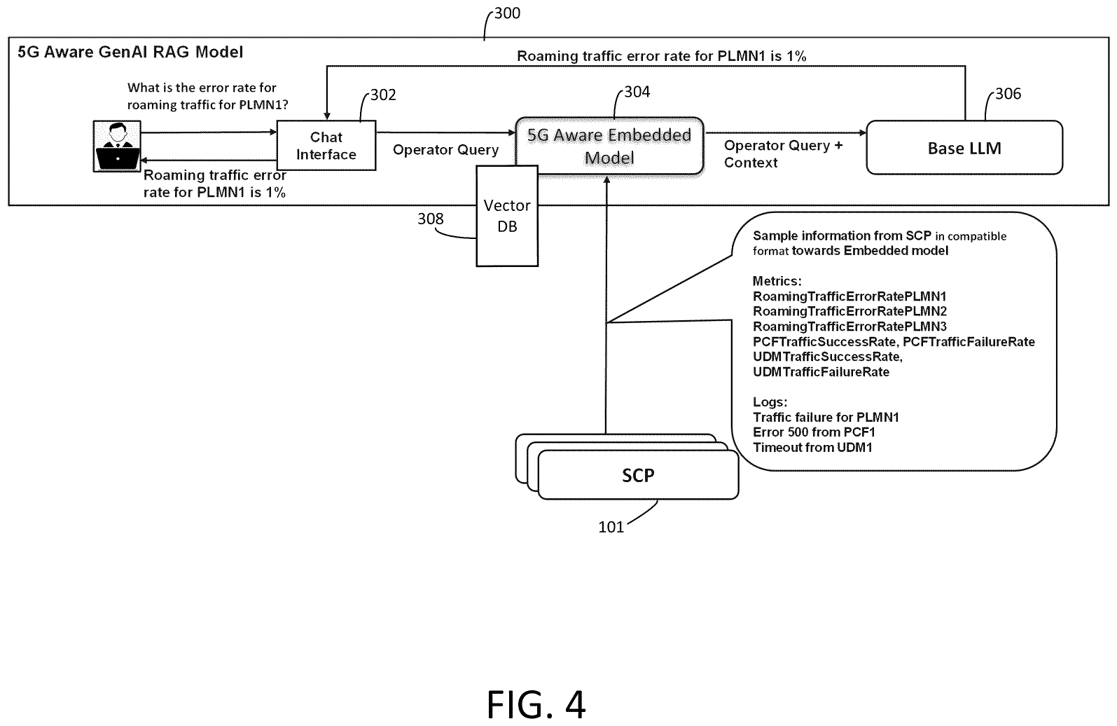

FIG. 4 is a block diagram illustrating exemplary implementation details of a communication-network-aware generative AI RAG model and an SCP for providing access to communication network health information. In FIG. 4, SCP 101 provides a continuous feed of health information to communication-network-aware embedded model 304. In the illustrated example, this information includes the following metrics and log information: Metrics:
RoamingTrafficErrorRatePLMN1
RoamingTrafficErrorRatePLMN2
RoamingTrafficErrorRatePLMN3
PCFTrafficSuccessRate, PCFTrafficFailureRate
UDMTrafficSuccessRate, UDMTrafficFailureRate
Logs:
Traffic failure for PLMN1
Error 500 from PCF1
Timeout from UDM1
   Communication-network-aware embedded model 304 tokenizes the information, forms the tokens into vectors, and stores the vectors in vector database 308. An example of the vectorized version of the network health information above is as follows:

To use communication-network-aware generative AI RAG model 300, a user inputs a query via chat interface 302. In the illustrated example, the query is, “What is the error rate for roaming traffic for PLMN1?” Communication-network-aware embedded model 304 reads tokens from the query, uses the tokens to access vector database 308, extracts one or more vectors of communication network health information, and provides the vectors along with the query to base LLM 306. Base LLM 306 uses the query and the context information to generate a query response in natural language format. In the illustrated example, the query response is, “Roaming traffic error rate for PLMN1 is 1%. ” Base LLM 306 provides the response to the user via chat interface 302.

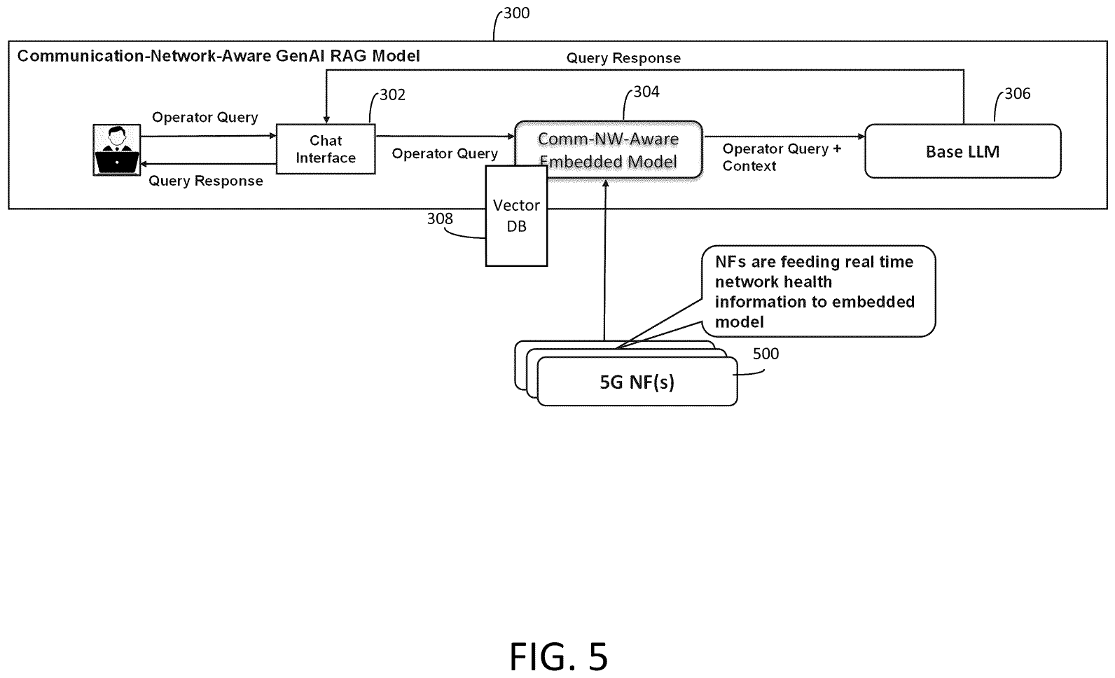

In the examples illustrated in FIGS. 3 and 4, communication-network-aware generative AI RAG model 300 receives network health information from SCP 101. While obtaining the network health information from SCP 101 is efficient in networks that route traffic via an SCP, the subject matter described herein is not limited to obtaining network health information from an SCP. Obtaining network health information from any one or more NFs is intended to be within the scope of the subject matter described herein. FIG. 5 is a block diagram illustrating exemplary components of a communication-network-aware generative AI RAG model and a plurality of 5G NFs for providing access to communication network health information. In FIG. 5, the network health information provided to communication-network-aware generative AI RAG model 300 is provided by one or more 5G NFs 500, where the 5G NFs can be any of the NF types illustrated in FIG. 1 or FIG. 2. Other than the source of the network health information feed, the operation of communication-network-aware generative AI RAG model 300 in FIG. 5 is the same as that illustrated in FIGS. 3 and 4.

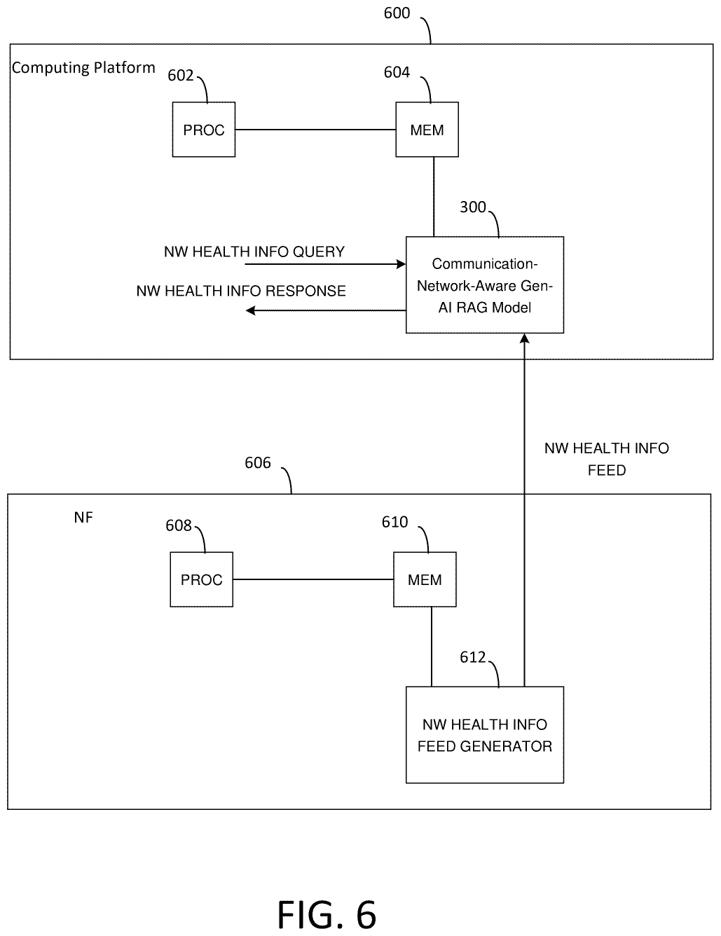

FIG. 6 is a block diagram illustrating a computing platform and a communication-network-aware generative AI RAG model implemented on the computing platform, and an NF for providing a feed of network health data to the communication-network-aware generative AI RAG model. Referring to FIG. 6 a computing platform 600 includes at least one processor 602 and memory 604. Computing platform 600 further includes communication-network-aware generative AI RAG model 300. Communication-network-aware generative AI RAG model 300 may be implemented using computer-executable instructions stored in memory 604 and executed by processor 602. Communication-network-aware generative AI RAG model 300 receives a continuous, real-time feed of network health information from one or more NFs 606. NF 606 may be any of the NFs described above with regard to FIGS. 1 and 2, including SCP 101. NF 606 includes at least one processor 608 and memory 610. NF 606 further includes a network health information feed generator 612 that generates the feed of network health information and provides the feed to communication-network-aware generative AI RAG model 300. Network health information feed generator 612 may be implemented using computer-executable instructions stored in memory 610 and executed by processor 608.

Communication-network-aware generative AI RAG model 300 receives network health information queries and provides network health information responses in the manner described above with regard to FIGS. 3 and 4. Even though in FIG. 6 communication-network-aware generative AI RAG model 300 and NF are shown as being implemented using separate computing platforms, in a cloud native environment, it is understood that communication-network-aware generative AI RAG model 300 and NF 606 can be implemented on the same computing platform without departing from the scope of the subject matter described herein.

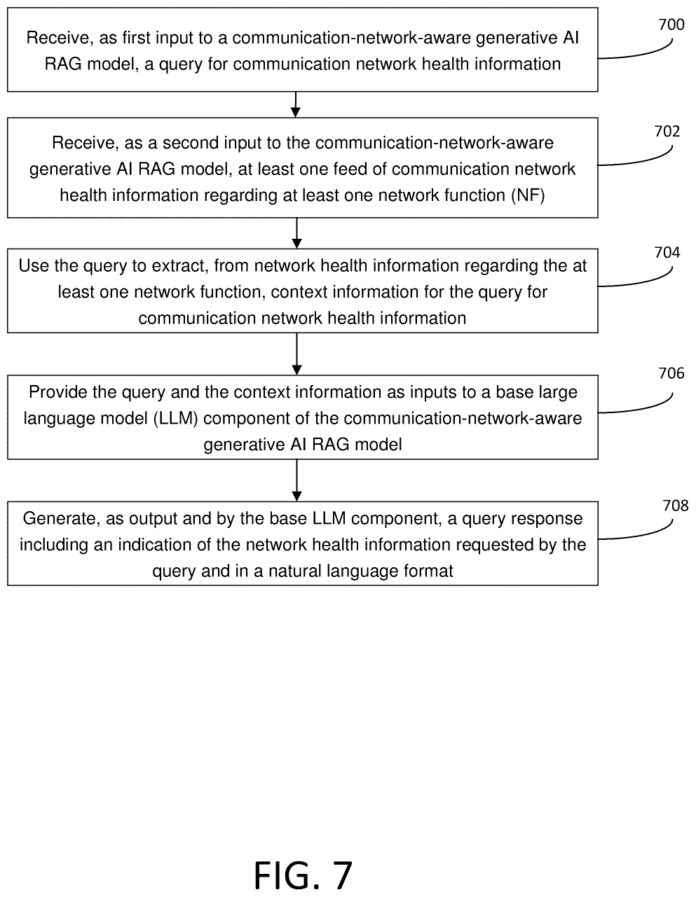

FIG. 7 is a flow chart illustrating an exemplary process for providing access to communication network health information using a communication-network-aware generative AI RAG model and an NF. Referring to FIG. 7, in step 700, the process includes receiving, as a first input to a communication-network-aware generative AI RAG model, a query for communication network health information. For example, a communication-network-aware generative AI RAG model, such as RAG model 300, may receive, from a network operator or other party, a query for network health information. In one example, the query is received in natural language format via a chat interface of the communication-network-aware generative AI RAG model.

In step 702, the process includes receiving, as a second input to the communication-network-aware generative AI RAG model, at least one feed of network health information regarding at least one network function (NF). For example, a network operator may provide feeds of network health information from one or more NFs to an embedded model component of the communication-network-aware generative AI RAG model.

In step 704, the process further includes using the query to extract, from the health information regarding the at least one network function, context information for the query for communication network health information. For example, a communication-network-aware generative AI RAG model, such as RAG model 300, may read one or more tokens from the query and use the tokens to perform a lookup in vector database 308 for one or more vectors that match the tokens from the query and extract the vectors with matching tokens as context information for the query.

In step 706, the process further includes providing the query and the context information as inputs to a base large language model (LLM) component of the communication-network-aware generative AI RAG model. For example, a communication-network-aware generative AI RAG model, such as RAG model 300, may provide the original query and the context information as inputs to base LLM 306.

In step 708, the process further includes generating, as output and by the base LLM component, a query response including an indication of the network health information requested by the query and in a natural language format. For example, based LLM 306 of communication-network-aware generative AI RAG model 300 may generate, as output, a query response including the requested network health information and in a natural language format.

Exemplary advantages of the subject matter described herein include providing a simplistic chat interface to a network operator's operation team to query the communication-network-aware generative AI RAG model for real time debugging and observability information. The solution described herein enables the network operations time to retrieve debugging information without limiting traffic to the NFs for maintenance. The solution described herein enables the network operations team to retrieve historical debugging information for any network service outages. The solution described herein can ingest network health information from any suitable NF.

The disclosure of each of the following references is hereby incorporated herein by reference in its entirety.

### REFERENCES

1. 3rd Generation Partnership Project; Technical Specification Group Services and System Aspects; System architecture for the 5G System (5GS); Stage 2 (Release 19) 3GPP TS 23.501 V19.0.0 (2024-06)
2. 3rd Generation Partnership Project; Technical Specification Group Core Network and Terminals; 5G System; Network Function Repository Services; Stage 3 (Release 18) 3GPP TS 29.510 V18.7.0 (2024-06)

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for providing access to communication network health information using a communication-network-aware generative artificial intelligence (AI) retrieval augmented generation (RAG) model, the method comprising:
receiving, as a first input to a communication-network-aware generative AI RAG model, a query for communication network health information;
receiving, as a second input to the communication-network-aware generative AI RAG model, at least one feed of communication network health information regarding at least one network function (NF);
using the query to extract, from the communication network health information regarding the at least one network function, context information for the query for communication network health information;
providing the query and the context information as inputs to a base large language model (LLM) component of the communication-network-aware generative AI RAG model; and
generating, as output and by the base LLM component, a query response including an indication of the communication network health information requested by the query and in a natural language format.

2. The method of claim 1 wherein the communication-network-aware generative AI RAG model comprises a 5G-network-aware generative AI RAG model.

3. The method of claim 1 wherein receiving the query includes receiving the query for communication network health information in a natural language format.

4. The method of claim 1 wherein receiving the query for communication network health information includes receiving the query requesting health status of a 5G network function.

5. The method of claim 1 wherein receiving the at least one feed of communication network health information includes receiving the at least one feed as input to a communication-network-aware embedded model component of the communication-network-aware generative AI RAG model and wherein the method further comprises storing the communication network health information regarding the at least one NF in a tokenized format in a vector database.

6. The method of claim 5 wherein using query to extract context information from the communication network health information regarding the at least one network function includes identifying one or more tokens in the query and using the one or more tokens to extract the health information regarding the at least one network function from the vector database.

7. The method of claim 1 wherein receiving the at least one feed of communication network health information regarding at least one NF includes receiving a plurality of feeds from a plurality of different NFs.

8. The method of claim 1 wherein receiving the at least one feed includes receiving a single feed of network health information from a service communication proxy (SCP) and including network health information regarding a plurality of different NFs.

9. The method of claim 1 wherein the communication-network-aware generative AI RAG model includes a chat interface and receiving the query for communication network health information includes receiving the query via the chat interface.

10. The method of claim 9 comprising providing the response to a user via the chat interface.

11. A system for providing access to communication network health information using a communication-network-aware generative artificial intelligence (AI) retrieval augmented generation (RAG) model, the system comprising:
at least one processor and a memory; and
a communication-network-aware generative AI RAG model stored in the memory and executed by the at least one processor for receiving, as a first input, a query for communication network health information, receiving, as a second input, at least one feed of communication network health information regarding at least one network function (NF), using the query to extract, from the communication network health information regarding the at least one network function, context information for the query for communication network health information, providing the query and the context information as inputs to a base large language model (LLM) component of the communication-network-aware generative AI RAG model, and generating, as output and by the base LLM component, a query response including an indication of the communication network health information requested by the query and in a natural language format.

12. The system of claim 11 wherein the communication-network-aware generative AI RAG model comprises a 5G-network-aware generative AI RAG model.

13. The system of claim 11 wherein the query is in a natural language format.

14. The system of claim 11 wherein the query requests health status of a 5G network function.

15. The system of claim 11 wherein the communication-network-aware generative AI RAG model includes a communication-network-aware embedded model component configured to receive the at least one feed as input and store the communication network health information regarding the at least one NF in a tokenized format in a vector database.

16. The system of claim 15 wherein the communication-network-aware embedded model component is configured to use the query to extract the context information from the communication network health information regarding the at least one network function by identifying one or more tokens in the query and using the one or more tokens to extract the health information regarding the at least one network function from the vector database.

17. The system of claim 11 wherein the communication-network-aware generative AI RAG model is configured to receive a plurality of feeds of communication network health information from a plurality of different NFs.

18. The system of claim 11 wherein the communication-network-aware generative AI RAG model is configured to receive a single feed of network health information from a service communication proxy (SCP) and including network health information regarding a plurality of different NFs.

19. The system of claim 11 wherein the communication-network-aware generative AI RAG model includes a chat interface configured to receive the query for communication network health information.

20. One or more non-transitory computer readable media having stored thereon executable instructions that when executed by one or more processors of one or more computers control the one or more computers to perform steps comprising:
receiving, as a first input to a communication-network-aware generative artificial intelligence (AI) retrieval augmented generation (RAG) model, a query for communication network health information;
providing, as a second input to the communication-network-aware generative AI RAG model, at least one feed of communication network health information regarding at least one network function (NF);
using the query to extract, from the communication network health information regarding the at least one network function, context information for the query for communication network health information;
providing the query and the context information as inputs to a base large language model (LLM) component of the communication-network-aware generative AI RAG model; and
generating, as output and by the base LLM component, a query response including an indication of the communication network health information requested by the query and in a natural language format.
